(19) United States
(12) Patent Application Publication
(10) Pub. No.: US 2015/0262135 A1
(43) Pub. Date: Sep. 17, 2015

(54) COMMUNICATION PROTOCOLS TO ALLOCATE AND APPLY RESOURCES IN A COMPUTING SYSTEM HAVING MULTIPLE COMPUTERS CONNECTED VIA COMMUNICATION NETWORKS

(71) Applicant: Visa International Service Association, San Francisco, CA (US)

(72) Inventors: Jeanette Yoder, San Mateo, CA (US); Nikolaos Stamatis, San Francisco, CA (US)

(21) Appl. No.: 14/643,293

(22) Filed: Mar. 10, 2015

Related U.S. Application Data
(60) Provisional application No. 61/953,505, filed on Mar. 14, 2014.

(51) Int. Cl. G06Q 20/02; H04L 29/08; H04L 12/927; G06Q 20/40; H04L 12/911

(52) U.S. Cl. CPC G06Q 20/027; G06Q 20/40; H04L 47/828; H04L 47/80; H04L 67/10

(57) ABSTRACT

A computer system having a plurality of computers, including a centralized router and a data storage stores data linking a time limit and multiple destination accounts. Within the time limit, in response to a first authorization request associated with a first destination account, the data storage stores data linking an account identifier provided in the first authorization request with the time limit; in response to a second authorization request identifying the account identifier and being associated with a second destination account, the data storage stores data increases an allocated resource of the account identifier; and in response to a third authorization request identifying the account identifier and being associated with a third destination account, the centralized router applies the allocated resource of the account identifier to generate a fourth authorization request replacing the third authorization request and routes a response to the fourth authorization request.

### RELATED APPLICATIONS

The present application claims priority to Prov. U.S. Pat. App. Ser. No. 61/953,505, filed Mar. 14, 2014, the entire disclosure of which is hereby incorporated herein by reference.

### FIELD OF THE TECHNOLOGY

At least some embodiments presented in the disclosure relate to a computing system having a plurality of computers connected via one or more networks in general and, more particularly but not limited to, protocols for communication among a plurality of computers for allocation and application of resources to be transferred.

### BACKGROUND

The Internet provides a communication channel for flexible communication connections among various computing devices connected to it. For example, web browsers running in computing devices may access web servers via standardized communication protocols, such as Hypertext Transfer Protocol (HTTP), Hypertext Transfer Protocol Secure (HTTPS), File Transfer Protocol (FTP), etc.

For security reasons, reliability reasons, and/or other reasons, certain computers are interconnected via propriety networks and/or dedicated network connections. For example, certain computers configured with high security considerations may be connected via dedicated network connections. For example, financial transaction card originated messages transmitted in accordance with ISO 8583 are generally propagated in secure networks.

Combining existing propriety networks and/or dedicated network connections with open connections offered by the Internet may offer advantages in some instances.

### BRIEF DESCRIPTION OF THE DRAWINGS

The embodiments are illustrated by way of example and not limitation in the figures of the accompanying drawings in which like references indicate similar elements.

FIG. 1 shows a computing system in which communication techniques of embodiments disclosed herein can be used.

FIG. 2 shows an example of a portion of a system in which the communication techniques of one embodiment can be used.

FIGS. 3-6 show communication protocols to allocate and apply resources according to some embodiments.

FIG. 7 shows a loyalty reward system supported by non-competing merchants from different industries according to one embodiment.

FIG. 8 shows a payment processing system in which the communication techniques can be used according to one embodiment.

FIG. 9 illustrates a transaction terminal according to one embodiment.

FIG. 10 illustrates an account identifying device according to one embodiment.

FIG. 11 illustrates a data processing system according to one embodiment.

### DETAILED DESCRIPTION

In one embodiment, a communication protocol is provided in a computing system having multiple computers connected via multiple networks to facilitate the allocation of resources and application of the allocated resources in connection with the authorization of the transfer of resources.

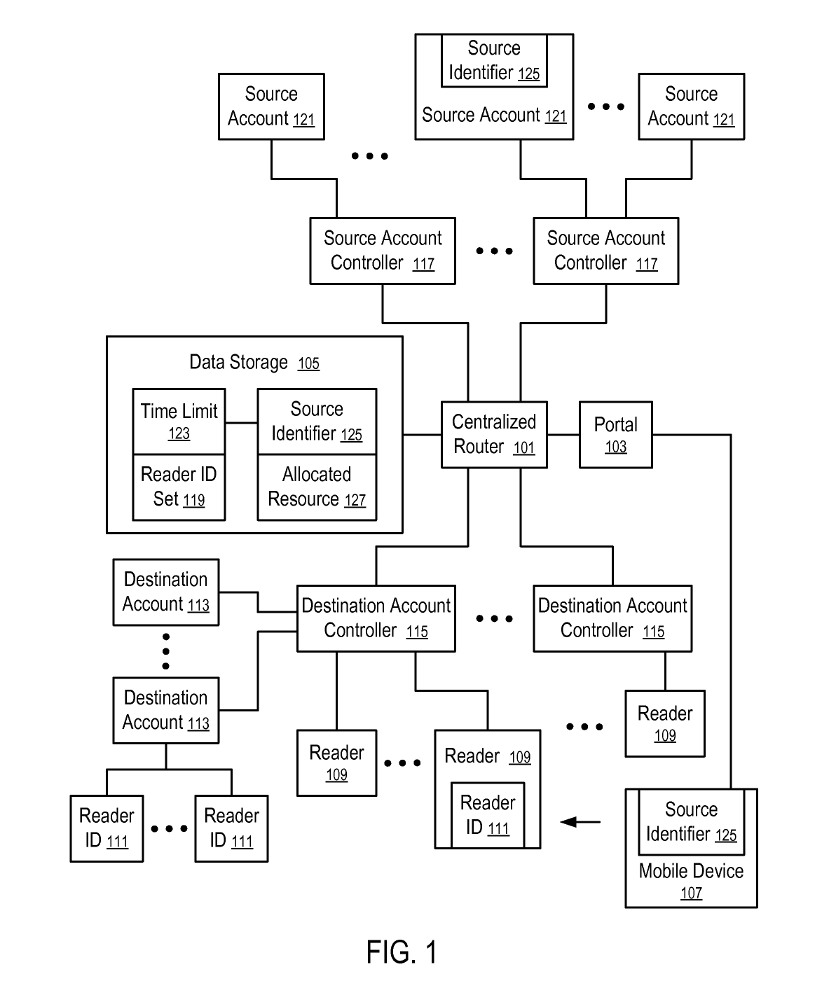

FIG. 1 shows a computing system in which communication techniques of embodiments disclosed herein can be used.

In FIG. 1, resources can be transferred from source accounts (121) to destination accounts (113) in response to interactions between mobile devices (107) that present source identifiers (125) and readers (109) that are associated with destination accounts (113).

In FIG. 1, the destination account controllers (115) are computers that control destination accounts (113). Each of the destination account controllers (115) controls their respective sets of one or more destination accounts (113). Each destination account (113) is associated with one or more reader IDs (111) of readers (109). Each reader (109) has a unique reader ID (111) that can be used to identify the destination account (113) represented by the reader (109). Thus, when an authorization request for a resource transfer is originated in a reader (109) that has a reader ID (111) and that is connected to a destination account controller (115), the authorization request is considered for a transfer to a destination account (113) that is controlled by the destination account controller (115) and that is associated with the corresponding reader ID (111).

In FIG. 1, the source accounts controllers (117) are computers that control source accounts (121). Each of the source account controllers (117) controls their respective set of one or more source accounts (121). Each of the source accounts (121) in the system is uniquely identified by a source identifier (125). Each of the mobile devices (107) is configured to present a source identifier (125) to any of the readers (109) during a communication interaction.

In a communication interaction between a mobile device (107) and a reader (109), the reader (109) obtains the source identifier (125) from the mobile device (107) and generates an authorization request for the transfer of resources from the source account (121) identified by the source identifier (125) obtained from the mobile device (107) to a destination account (113) identified by the reader (109) having the reader ID (111) and connected to the destination account controller (115) of the respective destination account (113) that is associated with the same reader ID (111).

In FIG. 1, the authorization request is to be approved by the centralized router (101) and/or the respective source account (121) having the source identifier (125) in accordance with predetermined security policies.

In FIG. 1, the centralized router (101) is a set of one or more computers coupled between the source account controllers (117) and the destination account controllers (115). Each of the destination account controllers (115) is connected to the centralized router (101) to communicate authorization requests to the centralized router (101) and to receive from the centralized router (101) respective authorization responses corresponding to the respective authorization requests.

In FIG. 1, each of the source account controllers (117) is connected to the centralized router (101) to receive authorization requests from the centralized router (101) and to transmit to the centralized router (101) respective authorization responses corresponding to the respective authorization requests.

In FIG. 1, the centralized router (101) routes the authorization requests for transfers from source accounts (121) identified by respective source identifiers (125) to respective source account controllers (117) based on the association between the source account controllers (117) and the source identifiers (125).

In FIG. 1, the centralized router (101) routes the authorization responses for transfers to destination accounts (113) to respective destination account controllers (115) based on the identification information of the destination account controllers (115) and/or the destination accounts (113) that are received in respective authorization requests.

Thus, the centralized router (101) routes an authorization request, originated by a reader (109) interacting with a mobile device (107) having the source identifier (125), from a destination account controller (115) connected to the reader (109) to the source account controller (117) identified by the source identifier (125), and receives the authorization response from the source account controller (117) and routes the authorization response back to the respective destination account controller (115), which provides the authorization response to the respective reader (109). In one embodiment, the communication messages between the centralized router (101) and the source account controllers (117) or the destination account controllers (115) are in accordance with a published standard to support interoperability, such as ISO 8583.

In one embodiment, each of the readers (109) is a separate computer disposed at a different location. A mobile device (107) is configured with a source identifier (125) to be read by the reader (109); e.g., via scanning using laser, reading a magnetic data strip mounted on a plastic card, or reading via near field communications. In some instances, the source identifier (125) may be read by a person and entered manually in the reader (109) via a keypad.

In FIG. 1, a portal (103) is provided to allow a direct connection to the mobile deice (107) without going through the readers (109) and/or the destination account controllers (115). For example, the connection between the portal (103) and the mobile device (107) can be established via the Internet and/or wireless communication connections, such as cellular communication connections, wide area wireless network connections, etc. In one embodiment, the connection between the portal (103) and the mobile device (107) is used for the communication of information not directly relevant to the destination accounts (113).

In some embodiments, the portal (103) also provides a direct connection to the reader (109) without going through its destination controller (115). For example, the reader (109) may establish a connection with the portal (103) over the Internet, without using the network connection between the reader (109) and its destination account controller (115). For example, the reader (109) can be configured to communicate with the portal (103) over the Internet using Hypertext Transfer Protocol (HTTP), Hypertext Transfer Protocol Secure (HTTPS), File Transfer Protocol (FTP), etc.

In FIG. 1, the portal (103) is a set of one or more computers separate from the centralized router (101). However, the portal (103) is connected with the centralized router (101) (e.g., via an intranet) for secure data communications.

In FIG. 1, both the centralized router (101) and the portal (103) have access to the shared data storage (105).

In FIG. 1, the data storage (105) is configured to store data including the allocated resource (127) for a source identifier (125), a time limit (123) for expiration of the allocated resource (127), and a reader ID set (119) identifying applicable readers (109) or destination accounts (113) that are relevant to the allocation and application of the resource (127).

At least some embodiments presented in the disclosure provide communication protocols for the multiple computers, connected via the various network connections illustrated in FIG. 1, to process authorization requests originated by the readers (109) reading the source identifier (125) from the mobile device (107), in view of the data stored in the data storage (105) identifying the reader ID set (119) and the time limit (123) to allocate the resource (127) for the source identifier (125) and to apply the allocated resource (127).

In one embodiment, the reader ID set (119) identifies the reader IDs (111) of a plurality of readers (109) disposed in different locations. The techniques provided herein allow the coordination of the different computers to allocate and apply the allocated resource (127) in connection with the processing of authorization requests initiated on the set of readers (109).

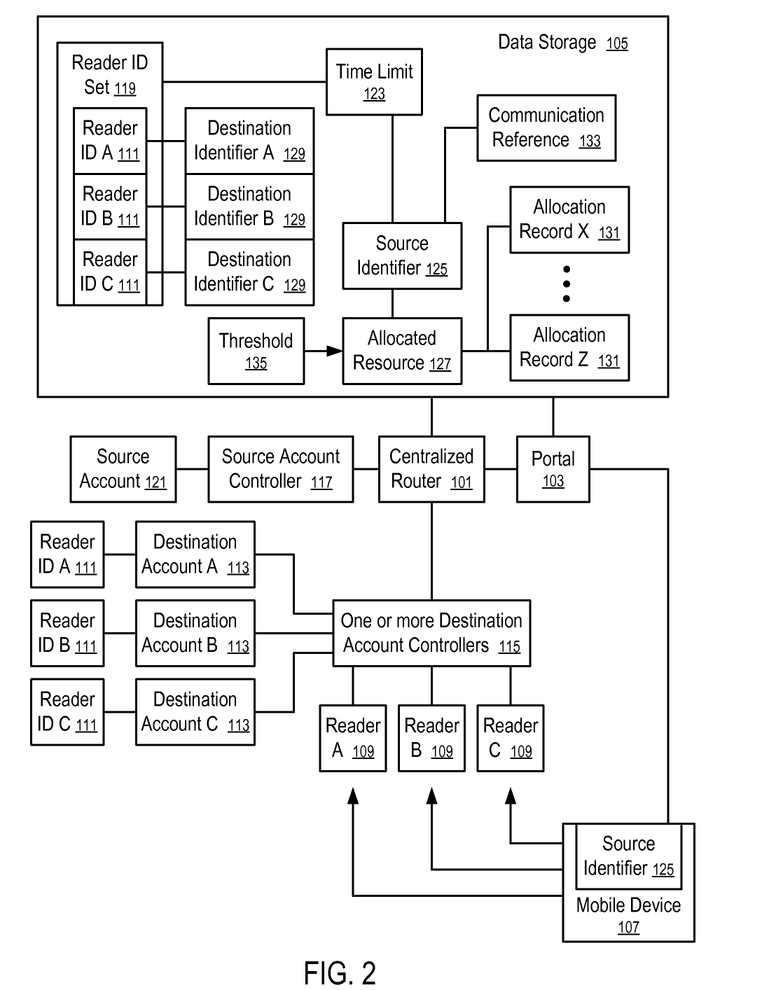

FIG. 2 shows an example of a portion of a system in which the communication techniques of one embodiment can be used. Some components shown in FIG. 1 are not illustrated in FIG. 2 for clarity, while other components are illustrated with further details.

FIG. 2 illustrates an example involving three different destination accounts A, B and C (113). Each of the readers A, B and C (109) represents a typical reader (109) connected to a corresponding destination account controller (115) of a corresponding destination account (113) in destination accounts A, B and C (113). The readers A, B and C (109) have the corresponding reader IDs A, B and C (111) that are associated with the destination accounts A, B and C (113), respectively.

In FIG. 2, the data storage (105) stores data linking each of the reader IDs A, B and C (111) to a corresponding destination identifier (129). The destination identifiers A, B and C (129) uniquely identify the destination accounts A, B and C (113), respectively.

Although FIG. 2 shows one reader (109) for each destination account (113), a destination account (113) in general has one or more readers (109). The reader (109) shown in FIG. 2 for a destination account (113) is representative of other readers (109) of the destination account (113).

Although FIG. 2 shows an example involving three different destination accounts A, B and C (113), the techniques disclosed herein can be applied to other reader ID sets (119) involving more or fewer destination accounts (113). For example, some embodiments may involve two or fewer destination accounts (113), while other embodiments may involve four or more destination accounts (113).

In FIG. 2, the destination accounts A, B and C (113) can be under the control of the same destination controller (115) in one embodiment, and different destination controllers (115) in other embodiments.

In FIG. 2, the centralized router (101) communicates with the source account controller (117) controlling a source account (121) identified by the source identifier (125) configured in the mobile device (107) and the destination account controllers (115) during the processing of the authorization requests originated by the readers A, B and C (109) as results of communication interactions between the mobile device (107) having the source identifier (125) and the respective readers A, B, and C (109).

In one embodiment, based on the data stored in the data storage (105) that identifies the destination identifiers (129) and/or the reader IDs (111), the centralized router (101) and the portal (103) further communicate with other components within the system, as further discussed below, to establish the connection between the source identifier (125) and a communication reference (133) of the mobile device (107), allocate the resource (127), store the allocation records (131), and apply the allocated resource (127).

In one embodiment, the data storage (105) stores data identifying the time limit (123) and a threshold (135). The allocated resource (127) is allocated within the time limit (123), and the allocated resource (127) is applied when the allocated resource (127) exceeds the threshold (135). In some embodiments, the application of the allocated resource (127) is also controlled by the time limit (123) (or by a different time limit (123) from the allocation of the resources (127)).

FIG. 2 illustrates one mobile device (107). In general, the system can be expanded to allocate and apply resources in a similar way for other mobile devices (107) configured in the system. In some embodiments, separate mobile devices (107) can be used to present the source identifier (125) and communicate with the portal (103).

In one embodiment, during the processing of an authorization request originated from a reader (109) associated with one of the destination accounts (113), the authorization request is processed to establish, in the data storage (105), the data linking of the source identifier (125) and the time limit (123), and the data linking the source identifier (125) and the communication reference (133). Subsequently and within the time limit (123), during the processing of an authorization request originated from a reader (109) associated with one of the destination accounts (113), the centralized router (101) or the portal (103) allocates a portion of the resource being authorized for the authorization request as part of the allocated resource (127), and stores a corresponding allocation record (131) identifying the allocation. Resources allocated for the source identifier (125) are accumulated during the time limit (123). After the allocated resource (127) is above the threshold (135) and during the processing of an authorization request originated from a reader (109) associated with one of the destination accounts (113), the allocated resource (127) is applied to the authorization of the authorization request.

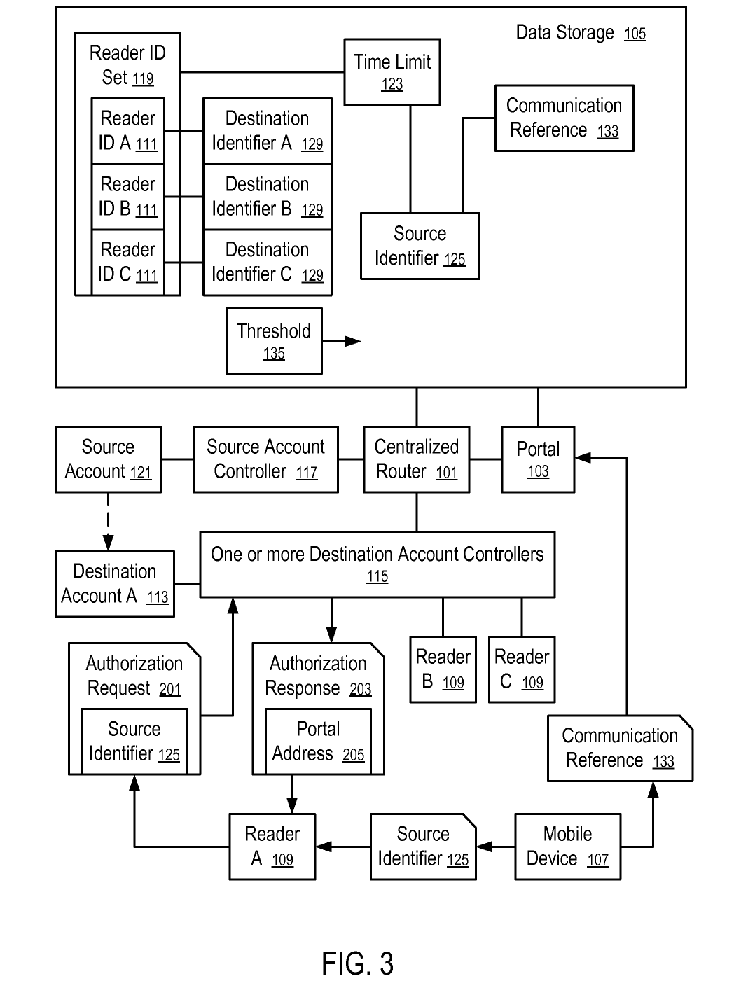

FIGS. 3-6 show communication protocols to allocate and apply resources according to some embodiments.

In FIG. 3, after the reader A (109) obtains the source identifier (125) from the mobile device (107), the reader (109) initiates a first authorization request (201) that identifies the source identifier (125) for a transfer from the source account (121) to the destination account A (113) that is associated with the reader A (109).

The reader (109) transmits the first authorization request (201) to its destination account controller (115). The centralized router (101) routes the first authorization request (201) from the destination account controller (115) to the source account controller (117) that controls the source account (121) in a way as illustrated in FIGS. 1 and 2.

In FIG. 3, after receiving the response to the first authorization request (201) from the source account controller (117), the centralized router (101) provides a portal address (205) in an authorization response (203) and propagates the authorization response (203) back to the reader (109) via its destination account controller (115). The reader (109) provides the portal address (205), which can be used by the mobile device (107) to visit the portal (103) via a communication connection that does not go through the reader (109) and/or the destination account controller (115). During the visit to the portal (103), the mobile device (107) provides the communication reference (133) to the portal (103). The portal (103) then stores data in the data storage (105) to link the source identifier (125) to the time limit (123) and the communication reference (133) that can be used by the portal (103) to subsequently establish a direct communication connection with the mobile device (107) without going through any of the readers (109) and/or destination account controllers (115).

In one embodiment of FIG. 3, the portal address (205) is provided in the authorization response (203) in response to an authorization request (201) from a reader (109) associated with a pre-selected one of the destination identifiers (129). Alternatively, the portal address (205) may be provided in the authorization response (203) in response to an authorization request (201) from a reader (109) associated with any of the destination identifiers (129) associated with the reader ID set (119).

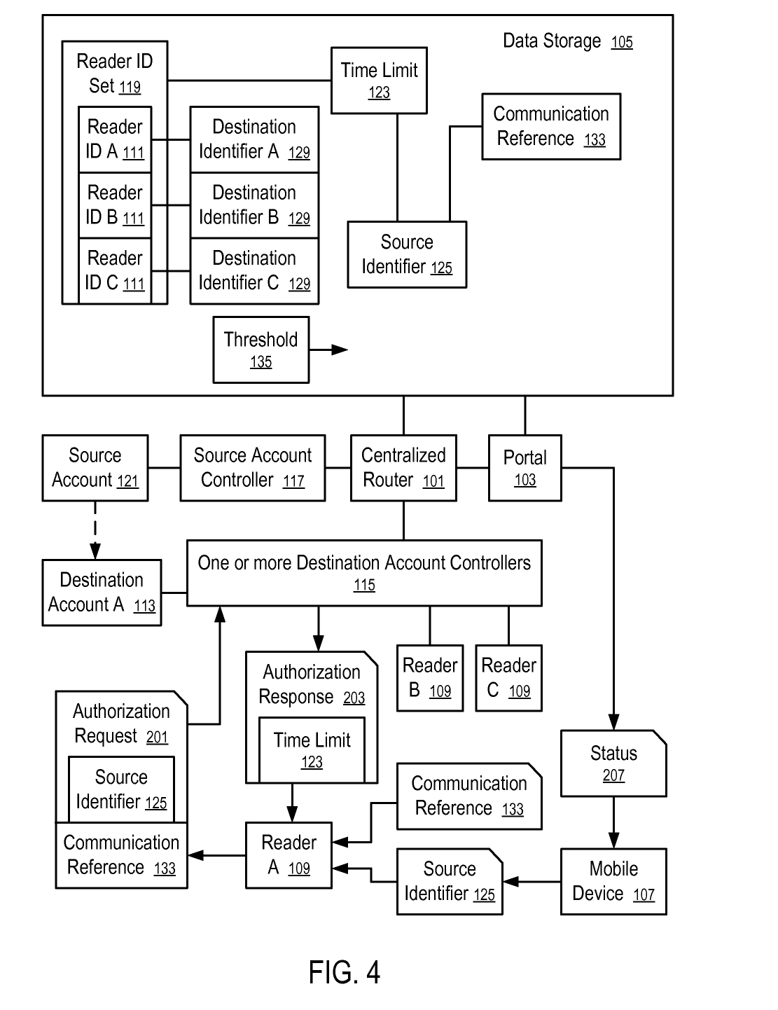

FIG. 4 illustrates an embodiment in which the communication reference (133) is provided in the first authorization request (201).

In FIG. 4, the reader A (109) obtains the communication reference (133), in addition to obtaining the source identifier (125), to initiate the authorization request (201). Thus, both the source identifier (125) and the communication reference (133) are transmitted to the destination account controller (115) of the reader (109) for improved efficiency.

In response to the first authorization request (201) that contains the source identifier (125) and the communication reference (133), the centralized router (101) stores data in the data storage (105) to link the source identifier (125) to the time limit (123) and the communication reference (133).

In one embodiment, the centralized router (101) may optionally provide the time limit (123) in the authorization response (203) that is responsive to the first authorization request (201). The time limit (123) indicates that the data storage (105) is now properly configured to allocate resources based on the reader ID set (119) within the time limit (123). The portal (103) may use the communication reference (133) to establish a communication connection that does not go through the readers (109) to provide the status (207) of the allocation of resources. For example, the initial status (207) can be provided in parallel with the authorization response (203), which may optionally include the time limit (123) and/or other indicators of the onset of the resource allocation.

In one embodiment of FIG. 4, the centralized router (101) or the portal (103) is configured to store the data linking the source identifier (125) to the time limit (123) and the communication reference (133) in response to an authorization request (201) from a reader (109) associated with a pre-selected one of the destination identifiers (129). Alternatively, the corresponding data can be stored in response to an authorization request (201), containing the source identifier (125) and the communication reference (133), from a reader (109) associated with any of the destination identifiers (129) associated with the reader ID set (119).

In one embodiment, to link the source identifier (125) to the time limit (123), the source identifier (125) is to meet a set of pre-determined criteria. In FIGS. 3 and 4, the reader (109) may communicate with the portal (103) via a connection that does not go through the destination account controller (115) of the reader (109) to determine if the portal address (205) is to be presented to the user of the mobile device (107) in FIG. 3, or to determine whether to request the communication reference (133) to initiate the first authorization request (201) in FIG. 4.

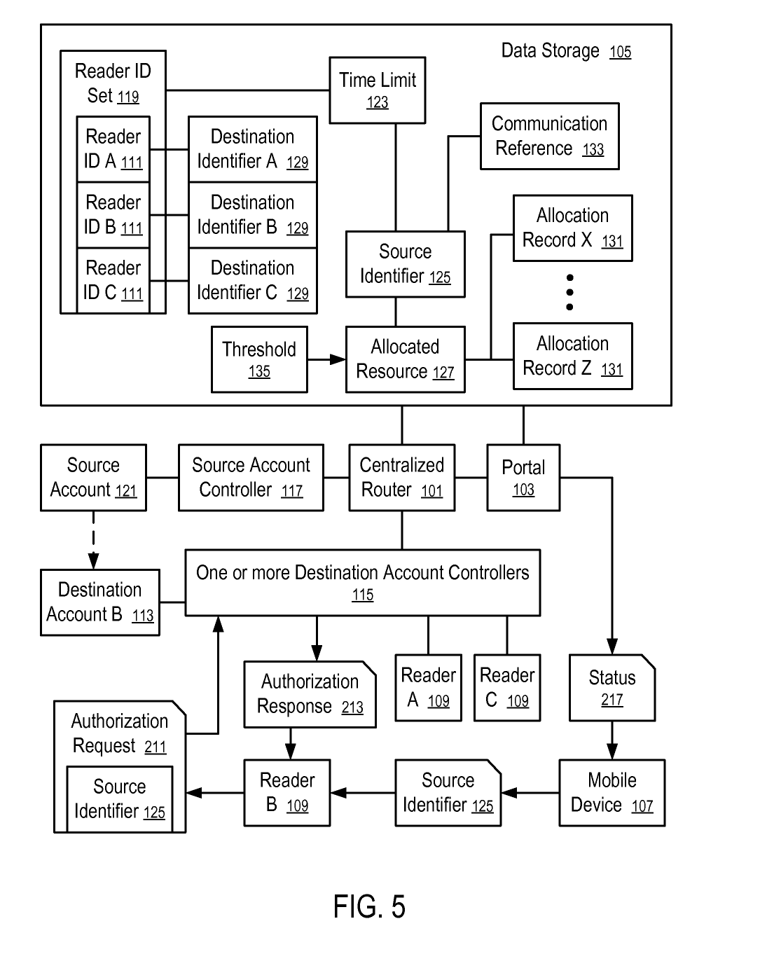

FIG. 5 illustrates an example of allocating resources according to one embodiment.

In FIG. 5, the reader B (109) obtains the source identifier (125) from the mobile device (107) to originate a second authorization request (211) for a resource transfer from the source account (121) identified by the source identifier (125) to the destination account B (113) having the destination identifier B (129) that is associated with the reader ID B (111) of the reader B (109).

After the second authorization request (211) is routed to or through the centralized router (101) from the destination account controller (115) of the reader B (109) to the source account controller (117) of the source account (121), the centralized router (101) or the portal (103) determines whether the source identifier (125) is associated with the time limit (123) and the second authorization request (211) is within the time limit (123).

If the source identifier (125) is associated with the time limit (123) and the second authorization request (211) is within the time limit (123), the centralized router (101) or the portal (103) increases the allocated resource (127) and stores a corresponding allocation record (131) for the increase.

For example, the allocation record (131) may include information identifying the destination account B (113) for the increase corresponding to the currently authorized transfer between the source account (121) and the destination account B (113). The allocation record (131) may identify the time and date of the increase and details of the currently authorized transfer, such as the authorized resource for transferring from the source account (121) and the destination account B (113).

In FIG. 5, the portal (103) transmits a status (217) of the allocated resource (127) in parallel with the centralized router (101) routing the authorization response (213) that is responsive to the second authorization request (211) to the reader B (109) via its destination account controller (115), which may or may not be the same as the destination account controller (115) of reader A or C (109).

Alternatively or in combination, the centralized router (101) may include a report of the allocated resource (127) in the authorization response (213) for presentation by the reader (109).

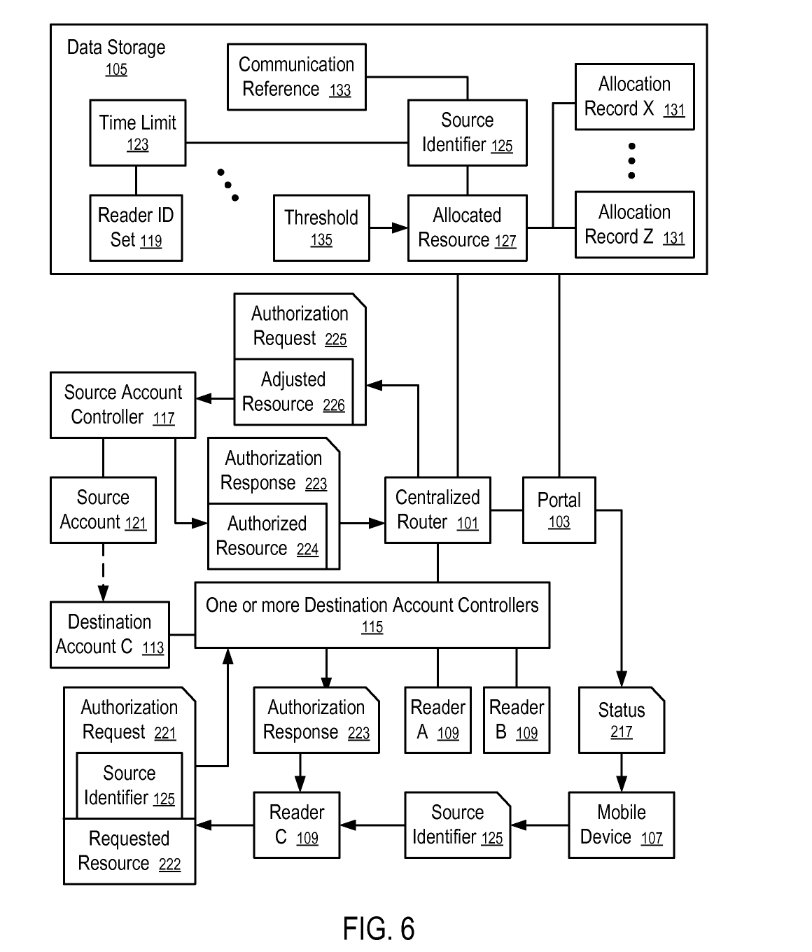

FIG. 6 illustrates an example of application resources according to one embodiment.

In FIG. 6, the reader C (109) obtains the source identifier (125) from the mobile device (107) to originate a third authorization request (221) for a resource transfer from the source account (121) identified by the source identifier (125) to the destination account C (113) having the destination identifier C (129) that is associated with the reader ID C (111) of the reader C (109).

In FIG. 6, the third authorization request (221) specifies the source identifier (125) and a requested resource (222).

After the third authorization request (221) is received in the centralized router (101) from the destination account controller (115) of the destination account C (113) associated with the reader C (109) and before the request is routed to the source account controller (117) of the source account (121), the centralized router (101) or the portal (103) determines whether the source identifier (125) is associated with the time limit (123) and the allocated resource (127) exceeds the threshold (135) (and/or other requirements, such as whether the third authorization request (221) is within the time limit (123)).

If the source identifier (125) is associated with the time limit (123) and the third authorization request (221) is within the time limit (123) (and/or other requirements are met, such as the third authorization request (221) is within the time limit (123)), the centralized router (101) or the portal (103) applies the allocated resource (127) to the requested transfer to the destination account C (113) by changing the requested resource (222) in the third authorization request (221) to the adjusted resource (226) in the fourth authorization request (225) transmitted to the source account controller (117). For example, the requested resource (222) may be reduced by the allocated resource (127) to determine the adjusted resource (226) requested to be transferred from the source account (121) to the destination account (113), in view of the allocated resource (127), which is now approved for being transferred to the destination account C (113) as part of the transfer to the destination account C (113).

The source account controller (117) provides an authorization response (223) to the fourth authorization request (225). In FIG. 6, the authorization response (223) indicates an authorized resource (224) to be transferred from the source account (121) to the destination account C (113) of the reader (109). The authorized resource (224) may be the same as the adjusted resource (226) if the source account (121) has sufficient resources. However, if the source account (121) has sufficient resources to meet the requirements of the adjusted resource (226), the source account controller (117) may specify the authorized resource (224) that is different from the adjusted resource (226), identified in the fourth authorization request (225).

In FIG. 6, the centralized router (101) routes the authorization response (223) to the reader C (109) via the destination account controller (115) of the destination account C (113), in a way as discussed in connection with FIGS. 1 and 2.

In some embodiments, the centralized router (101) modifies the authorization response (223) to include the authorization of the transfer of the allocated resource (127) as a modified, authorized resource (224) in an authorization response (223) propagated to the reader C (109) or an indication of the application of the allocated resource (127) to the currently authorized transfer.

In FIG. 6, the portal (103) transmits the status (217) of the application of the allocated resource (127) in parallel with the centralized router (101) routing the authorization response (223) that is responsive to the third authorization request (221) to the reader C (109) via its destination account controller (115), which may or may not be the same as the destination account controller (115) of reader A or B (109).

FIG. 5 illustrates an example of increasing the allocated resource (127) in response to the second authorization request (211) from the reader B (109). In some embodiments, the allocated resource (127) can be similarly increased in response to a similar authorization request originated from the reader A or C (109).

For example, an initial increase in the allocated resource (127) can be provided in response to the first authorization request (201) originated in the reader A (109) as illustrated in FIG. 4, after linking the source identifier (125) to the time limit (123).

For example, an increase in the allocated resource (127) can be provided in response to the third authorization request (221) originated in the reader C (109) as illustrated in FIG. 4, before or after the application of the allocated resource (127).

The communication techniques discussed in FIGS. 1-6 can be used in many applications. For example, the transfer of resources can have applications in the transfer of digital tokens, digital rights, payment currencies, loyalty rewards, etc. For example, the transfer of resources can have applications in the transfer of payment currencies in terms of financial currencies from payment accounts as source accounts (121) and reward currencies as the allocated resources (127). The allocation records (131) can be used to determine the share of the cost to be allocated to the respective destination accounts (113).

For example, in one embodiment, a transaction handler of an electronic payment processing network can be implemented as the centralized router (101). Acquirer processors controlling the merchant accounts can be implemented as the destination account controllers (115) of the destination accounts (113), and the issuer processors controlling the consumer payment accounts can be implemented as the source account controllers (117) of the source accounts (121). The transaction terminals of merchants can be implemented as the readers (109) configured to read payment devices, or account identification devices, implemented as the mobile device (107) illustrated in FIGS. 1 and 2.

For example, a system and method can be configured using the communication techniques discussed above to provide a collaborative loyalty program offer from a set of non-competing merchants from different industries to drive down customer acquisition cost. The loyalty program is effective in a predetermined time period, during which users enrolled in the loyalty program may earn and accumulate loyalty benefits from payment transactions made with merchants participating in the loyalty program, and redeem the loyalty benefits in payment transactions with one or more of the merchants participating in the loyalty program. The offer rules are configured to promote purchase frequency, cross shopping with multiple merchants, and/or cross shopping within a narrow promotional time frame. The system can process benefit provisioning and redemption in real time with the processing of the respective transactions in an automated way.

For example, a loyalty program can be configured to drive down customer acquisition cost. The loyalty program includes a set of non-competing merchants from different industries to collectively promote customer loyalty. Thus, the cost for acquiring and retaining customers can be reduced.

The loyalty program may feature a set of merchants (e.g., 3 merchants), each from a different industry that involves everyday spending categories (e.g., quick service restaurant, grocery, fuel). The loyalty program provides a promotion in a limited time period (e.g., during the summer of 2014). The loyalty program allows a user to enroll one or more payment accounts of the user to receive loyalty benefits from payment transactions made with the merchants featured in the loyalty program and redeem accumulated loyalty benefits in transactions with the merchants featured in the loyalty program.

For example, the user may use one of the enrolled payment accounts to make a payment for a qualified purchase at any of the participating merchants and earn a virtual punch towards discount at the point of sale (POS) during an eligible payment transaction. Punches earned from different merchants may be aggregated separately, or combined. A virtual punch earned from different merchants may qualify for a different amount of discount, or the same amount of discount. The loyalty program may run in a predetermined time period (e.g., 4 to 8 weeks, during the weekends of 3 weeks in the summer, etc.).

The loyalty benefits may be accumulated in terms of virtual punches, loyalty points, or value of discounts in a predetermined currency (e.g., U.S. dollar).

To prompt cross shopping, the loyalty program may require the user to earn the punches and/or use the punches via transactions with different participating merchants. For example, the loyalty program may render the virtual punches redeemable when the punches earned satisfy predetermined criteria, such as earned from at least two of the merchants, earned from a first merchant and redeemed with a second merchant, etc.

Preferably, the loyalty program provides a cooperative offer from a small number of non-competing merchants from different industries (e.g., quick service restaurants (QSR), grocery, fuel) to drive down the cost of acquiring new customers. The offer has a limited effective time period in which participating users may earn and redeem benefits, sponsored by the non-competing merchants across multiple industries (or by a third party, such as an issuer, or a manufacturer).

Using the techniques illustrated in FIGS. 1-6, the benefit provision and/or redemption can be processed in real time with the processing of the respective payment transactions that qualify for the benefit and/or satisfy the benefit redemption requirements.

The offer benefit can be earned across the set of merchants and burned across the set of merchants. A transaction handler is configured to track the offer benefits earned by the users, track the contributions of the merchants, and process the costs of the loyalty benefits in real time in accordance with the contributions of the merchants, without requiring the merchants to make benefit purchases ahead of time.

In one embodiment, the contributions of the merchants to fund the loyalty benefits are measured/determined based on the transaction amounts of the users with the respective merchants.

The loyalty program of one embodiment involves short term offers (e.g., from a few days to a few months), benefit earning and burning across multiple merchants, non-competing merchants from different industries, real time benefit tracking and cost settlement in view of merchant contributions.

Through the participation in the loyalty program, merchants in different industries can cooperatively cross market to customers of each other and drive down customer acquisition cost.

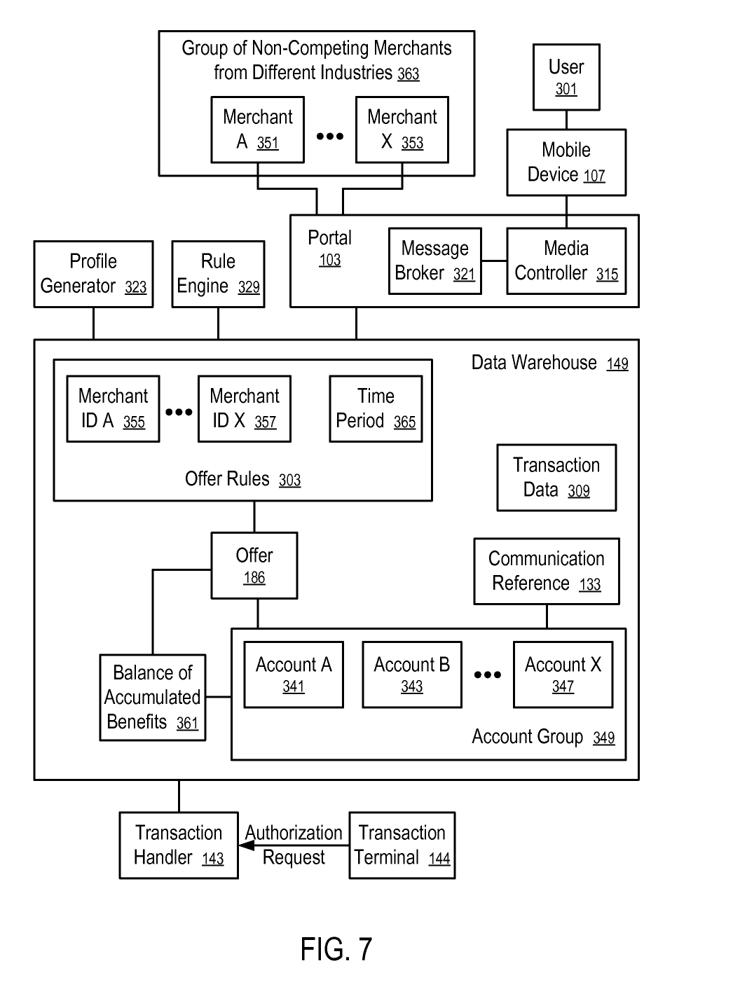

FIG. 7 shows a loyalty reward system supported by non-competing merchants from different industries (363) according to one embodiment.

In FIG. 7, the loyalty program includes a collaborative offer (186) from a plurality of merchants (351, . . . , 353) represented by the respective merchant IDs (355, . . . , 357).

In FIG. 7, the offer (186) is from a group (363) of non-competing merchants (351, . . . , 353) from different industries. Since each participating merchant of the offer (186) provides services and/or products in a different industry segment, where the merchants in the loyalty program do not compete with each other. Thus, referral of customers from one merchant to another in the loyalty program would not undermine the customer base of the referring merchant, and referring customers to each other within the group (363) of non-competing merchants from different industries (351, . . . , 353) can drive down the cost of customer acquisition. In one embodiment, the payment transactions associated with the non-competing merchants (351, . . . , 353) have different, non-overlapping merchant category codes.

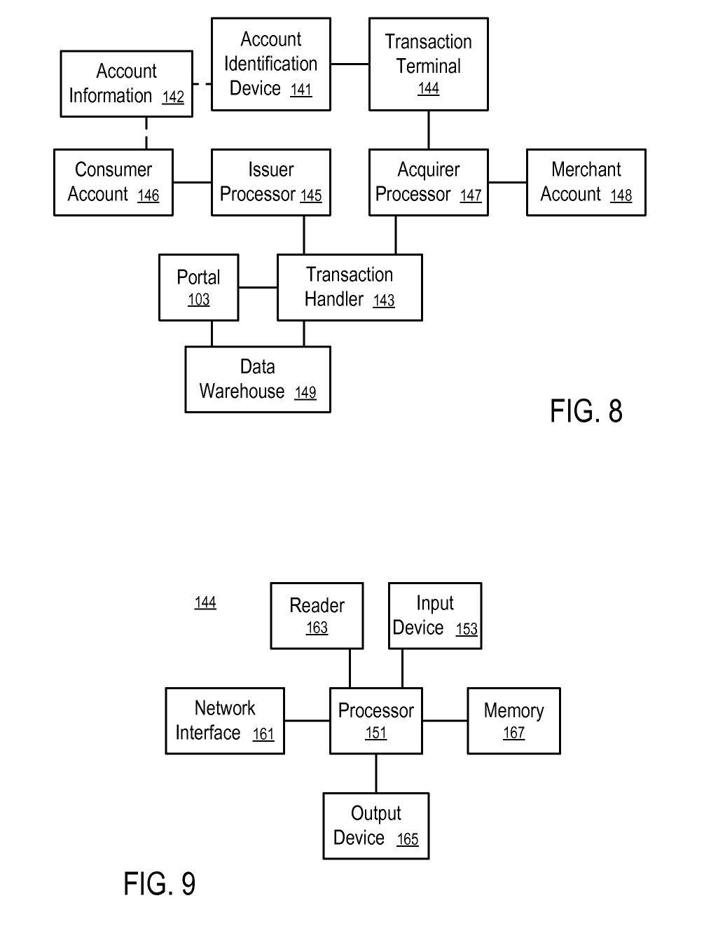

In FIG. 7, a data warehouse (149) is coupled with a transaction handler (143) of a payment processing network, such as the payment processing network illustrated in FIG. 8.

In FIG. 7, the data warehouse (149) stores the offer (186) and associated offer rules (303) for the loyalty program. The loyalty program has an effective time period (365) during which enrolled users (301) may earn benefits from first transactions with the non-competing merchants (351, . . . , 353) and redeem benefits for second transactions with the non-competing merchants (351, . . . , 353).

In one embodiment, the offer rules (303) are configured to drive purchase frequency, cross-ship with multiple merchants of the loyalty program, and/or encourage shopping within a narrow promotional time frame (e.g., weekends).

For example, the offer rules (303) may provide a first amount of discounts redeemable with a qualified transaction with any of the non-competing merchants from different industries (363) in the loyalty program when the user (301) earns a first threshold number of virtual punches from a first merchant (e.g., 351) in the loyalty program, and provide a second amount of discounts redeemable with a qualified transaction with any of the non-competing merchants from different industries (363) in the loyalty program when the user (301) earns a second threshold number of virtual punches from a second merchant (e.g., 353) in the loyalty program. The first amount of discounts may be different from the second amount of discounts, and the first threshold number may be different from the second threshold number. The virtual punches earned from different merchants (e.g., 351, . . . , 353) may be counted separately for the user (301) towards the respective threshold numbers, and different merchants (e.g., 351, . . . , 353) may have different requirements for a transaction to earn a virtual punch. For example, the first merchant (e.g., 351) may require a first minimum purchase amount for a transactions to earn a virtual punch, the second merchant (e.g., 353) may require a second minimum purchase amount for a transactions to earn a virtual punch, and the first minimum purchase amount and the second minimum purchase amount may be the same or different.

In one embodiment, the portal (103) coupled with the data warehouse (149) is configured to provide a user interface that allows the merchants (e.g., 351, . . . , 353) to specify the parameters for the offer rules (303), such as the amount of discounts provided when the threshold number of virtual punches is satisfied, the requirements of earning a virtual punch are satisfied, etc.

In some embodiments, the portal (103) includes a message broker (321) to generate messages for communicating to the mobile device (107) of the user (301) via a media controller (315) using the communication reference (133) associated with an account group (349) of the user (301).

In one embodiment, the virtual punches earned from different merchants (e.g., 351, . . . , 353) are combined for a count towards a threshold for a discount redeemable at a predetermined merchant (e.g., 351) in the group (363).

In one embodiment, each qualified transaction with one or more of the non-competing merchants from different industries in the group (363) provides a benefit (e.g., a virtual punch, a predetermined amount of discount, a discount proportional to a transaction amount, a number of loyalty points, etc.) that can be accumulated and redeemed at a predetermined merchant (e.g., 351) in the group (363) (or any merchant in the group (363) in another embodiment).

In FIG. 7, the user (301) may enroll a plurality of payment accounts (341, 343, . . . , 347) for the offer (186). The data warehouse (149) is configured to store the account group (349) in associated with the offer (186) to indicate the enrollment of the user (301) in the loyalty program. The user (301) may use any of the payment accounts (341, 343, . . . , 347) to make transactions to earn the loyalty benefits and/or redeem the loyalty benefits, in accordance with the offer rules (303), as if the payment accounts (341, 343, . . . , 347) were a single, same account.

In FIG. 7, the data warehouse (149) is configured to store the balance of accumulated benefits (361) earned via the qualified transactions made using the payment accounts (341, 343, . . . , 347) in the account group (349) of the enrolled user (301).

In FIG. 7, the portal (103) is configured to provide a user interface that allows the user (301) to add an account (e.g., 347) to the account group (349), remove an account (341, 343, . . . , 347) from the account group (349), view the balance (361) of the accumulated benefits under the offer (186), set redemption preferences, etc.

In one embodiment, the costs of the loyalty benefits are sponsored by the entity operating the data warehouse (149) and/or the transaction handler (143). Alternatively, or in combination, the costs of the loyalty benefits are sponsored by the merchants (351, . . . , 353) of the loyalty program, and the transaction handler (143) is configured to generate transactions to settle the cost of the benefit redeemed in a transaction in real time with the clearing and settlement of the transaction.

In one embodiment, the redemption of the accumulated benefits (361) is automated via the transaction handler (143). For example, when the user (301) uses a payment account (e.g., 341) in the account group (349) to make a payment transaction to a merchant (e.g., 351) in the merchant group (363), the transaction handler (143) receives the authorization request from a transaction terminal (144) of the merchant (e.g., 351) and determines whether the transaction meets the redemption requirements according to the offer rules (303) and if any, the redemption preferences of the user (301). If the redemption requirements and preferences are satisfied, the transaction handler (143) is configured to adjust the transaction to provide the redeemed benefit in an automated way without user input.

For example, when the cost of the benefit is at least partially sponsored by the merchant (e.g., 351) to which the payment is made in the transaction, the transaction handler (143) may adjust the transaction amount for the transaction in an authorization request to the respective issuer processor and/or the authorization response to the transaction terminal (144) of the merchant (e.g., 351), in a way as further described in U.S. Pat. App. Pub. Nos. 2013/0091000 and 2013/0124287, both entitled “Systems and Methods to Provide Discount at Point of Sales Terminals”, the entire disclosures of which applications are hereby incorporated herein by reference.

For example, when the cost of the benefit is at least partially sponsored by a third party (e.g., another merchant in the group (363), an issuer, a manufacture, an entity associated with the transaction handler (143)), the transaction handler (143) may split, in-line with the processing of, the transaction represented by the authorization request received from the transaction terminal (144) into two or more transactions involving the third party sponsors and the issuer of the payment account (341, 343, . . . , 347) used to initiated the authorization request and, combine inline the transactions for a single response to the authorization request from the transaction terminal (144) in a way as further described in U.S. Pat. App. Pub. Nos. 2013/0246150 and 2013/0282586, both entitled “Systems and Methods to Apply the Benefit of Offers via a Transaction Handler”, the entire disclosures of which applications are hereby incorporated herein by reference.

In one embodiment, the user (301) may optionally provide a communication reference (133) for association with the account group (349) to receive messages regarding the benefits earned and/or redeemed in the loyalty program, in real time with the transactions that earn the benefits and/or redeem the benefits. In response to the respective transactions, the message broker (321) is configured to generate the notification messages in accordance with the offer rules (303), and cause the media controller (315) to provide the messages in real time with respective transactions to the mobile device (107) of the user (301) identified by the communication reference (133).

In one embodiment, the transaction handler (143) and/or the portal (103) are configured to track the contributions of the merchants (351, . . . , 353) in the group for acquiring the business of the customers and determining the costs to be sponsored by the merchants (351, . . . , 353) based on the contributions of the merchants (351, . . . , 353).

In FIG. 7, a profile generator (323) is configured to use transaction data (309) to identify the number of new customers referred to the respective merchants (e.g., 351, . . . , 353) during the time period (365) of the loyalty program, and overall rise in transactions due to the loyalty program.

In one embodiment, a computing apparatus is configured to provide a collaborative offer (186) from a plurality of non-competing merchants (351, . . . , 353). During the predetermined time period (365), the computing apparatus is configured to monitor transactions in payment accounts (341, 343, . . . , 347) of users (301) who have accepted the offer (186), the transactions made to pay the non-competing merchants(351, . . . , 353), track benefits afforded to the users (301) in accordance with the offer (186) via the transactions, provide the benefits to qualified transactions of the users (301) with the non-competing merchants (351, . . . , 353), track contributions of the non-competing merchants (351, . . . , 353), and settle costs of the benefits among the non-competing merchants (351, . . . , 353)according to the tracked contributions.

In one embodiment, the computing apparatus is implemented using at least one data processing system, as illustrated in FIG. 7, having at least one microprocessor (173) and memory (167), storing instructions configured to instruct the at least one microprocessor (173) to perform the operations described herein. The computing apparatus includes at least one of: the data warehouse (149), the transaction handler (143), the portal (103), a rule engine (329), the profile generator (323), the message broker (321), and the media controller (315).

In one embodiment, the computing apparatus is configured to provide collaborative offers (186) from a plurality of non-competing merchants (501, . . . , 503), each of the merchants operating in a separate industry different from other merchants in the plurality of merchants. The offer (186) is not supported by any merchant that is in competition with any of the plurality of non-competing merchants (351, . . . , 353), and the offer (186) is effective within a predetermined time period (365). During the predetermined time period (365), the computing apparatus is configured to: monitor transactions made; pay the non-competing merchants (351, . . . , 353) in payment accounts (341, 343, . . . , 347) of users (301) who have accepted the offer (186); track benefits afforded to the users (301) in accordance with the offer (186) via the transactions; provide the benefits to qualified transactions of the users (301) with the non-competing merchants (351, . . . , 353); track contributions of the non-competing merchants (351, . . . , 353); and settle costs of the benefits among the non-competing merchants (351, . . . , 353) according to the tracked contributions.

In one embodiment, a benefit earned via a transaction with a first merchant (501) of the non-competing merchants (351, . . . , 353) is applicable to a transaction with a second merchant (503) of the non-competing merchants (351, . . . , 353).

In one embodiment, benefits (521) earned in accordance with the offer (186) in the predetermined time period (365) expire after the predetermined time period (365).

In one embodiment, the computing apparatus having at least one microprocessor (173) and memory (167) stores instructions configured to instruct the at least one microprocessor (173) to perform the various operations discussed herein.

In one embodiment, a non-transitory computer storage medium stores instructions configured to instruct the computing apparatus to perform the various operations discussed herein.

### VARIATIONS

Some embodiments use more or fewer components than those illustrated in the figures. For example, in some embodiments, the destination account controllers (115), the centralized router (101), and the source account controllers (117) may be operated by the same entity within an intranet. In one embodiment, the destination account controllers (115), the centralized router (101), and the source account controllers (117) may be implemented in the same set of one or more computers.

In some embodiments, the portal (103) is implemented using the same set of one or more computers of the centralized router (101).

### TRANSACTION PROCESSING

FIG. 8 shows a payment processing system in which the communication techniques can be used according to one embodiment.

In FIG. 8, the transaction handler (143) is coupled between an issuer processor (145) and an acquirer processor (147) to facilitate authorization and settlement of transactions between a consumer account (146) and a merchant account (148), in a way that the centralized router (101) is coupled between the destination account controllers (115) and the source account controllers (117). The transaction handler (143) records the transactions in the data warehouse (149). The portal (103) is coupled to the data warehouse (149) to provide an out-of-band communication access (e.g., via the Internet). The portal (103) may be implemented as a web portal, a telephone gateway, a file/data server, etc.

In FIG. 8, the transaction terminal (144) initiates the transaction for a user (301) (e.g., a customer) for processing by the transaction handler (143). The transaction handler (143) processes the transaction and stores the transaction data (309) about the transaction in connection with account information (142). The account information (142) may further include data about the user (301), collected from issuers or merchants (351, . . . , 353), and/or other sources, such as social networks, credit bureaus, merchant provided information, address information, etc. In one embodiment, a transaction may be initiated by a server (e.g., based on a stored schedule for recurrent payments).

In FIG. 8, the consumer account (146) is under the control of the issuer processor (145). The consumer account (146) may be owned by an individual or an organization such as a business, a school, etc. The consumer account (146) may be a credit account, a debit account, or a stored value account. The issuer may provide the consumer (e.g., user (301)) an account identification device (141) as the mobile device (107) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing the account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (144) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (144) may require contact with the account identification device (141) to read the account information (142) (e.g., by reading the magnetic strip of a card with a magnetic strip reader).

The transaction terminal (144) is configured to transmit an authorization request message to the acquirer processor (147). The authorization request includes the account information (142), an amount of payment, and information about the merchant (e.g., an indication of the merchant account (148)). The acquirer processor (147) asks the transaction handler (143) to process the authorization request based on the account information (142) received in the transaction terminal (144). The transaction handler (143) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (143), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (144) of one embodiment is configured to interact with the account identification device (141) to obtain the account information (142) that identifies the consumer account (146) and/or the issuer processor (145). The transaction terminal (144) communicates with the acquirer processor (147) that controls the merchant account (148) of a merchant. The transaction terminal (144) may communicate with the acquirer processor (147) via a data communication connection, such as a telephone connection, an Internet connection, etc. The acquirer processor (147) is to collect payments for deposit into the merchant account (148) on behalf of the merchant.

In one embodiment, the transaction terminal (144) is a POS terminal at a traditional, offline, “brick and mortar” retail store. In another embodiment, the transaction terminal (144) is an online server that receives the account information (142) of the consumer account (146) from the user (301) through a web connection. In one embodiment, the user (301) may provide account information (142) through a telephone call, via verbal communications with a representative of the merchant, and the representative enters the account information (142) into the transaction terminal (144) to initiate the transaction.

In one embodiment, the account information (142) can be entered directly into the transaction terminal (144) to make payments from the consumer account (146) without having to physically present the account identification device (141). When a transaction is initiated without physically presenting the account identification device (141), the transaction is classified as a “card-not-present” (CNP) transaction.

In general, the issuer processor (145) may control more than one consumer account (146), the acquirer processor (147) may control more than one merchant account (148), and the transaction handler (143) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (143), the issuer processor (145), the acquirer processor (147), the transaction terminal (144), the portal (103), and other devices and/or services accessing the portal (103) are connected via communications networks, such as local area networks, cellular telecommunications networks, wireless wide area networks, wireless local area networks, an intranet, and the Internet. Dedicated communication channels may be used between the transaction handler (143) and the issuer processor (145), between the transaction handler (143) and the acquirer processor (147), and/or between the portal (103) and the transaction handler (143).

In FIG. 8, the transaction handler (143) uses the data warehouse (149) to store the records about the transactions, such as the transaction records or the transaction data (309).

Typically, the transaction handler (143) is implemented using a powerful computer, or cluster of computers functioning as a unit, controlled by instructions stored on a computer-readable medium. The transaction handler (143) is configured to support and deliver authorization services, exception file services, and clearing and settlement services. The transaction handler (143) has a subsystem to process authorization requests and another subsystem to perform clearing and settlement services. The transaction handler (143) is configured to process different types of transactions, such credit card transactions, debit card transactions, prepaid card transactions, and other types of commercial transactions. The transaction handler (143) interconnects the issuer processors (e.g., 145) and the acquirer processor (e.g., 147) to facilitate payment communications.

In FIG. 8, the transaction terminal (144) is configured to submit the authorized transactions to the acquirer processor (147) for settlement. The amount for the settlement may be different from the amount specified in the authorization request. The transaction handler (143) is coupled between the issuer processor (145) and the acquirer processor (147) to facilitate the clearing and settling of the transaction. Clearing includes the exchange of financial information between the issuer processor (145) and the acquirer processor (147), and settlement includes the exchange of funds.

In FIG. 8, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (143) to coordinate the transfer of funds for the transaction. The funds can be transferred electronically.

The transaction terminal (144) may submit a transaction directly for settlement, without having to separately submit an authorization request.

In one embodiment, the portal (103) provides a user interface to allow the user (301) to organize the transactions in one or more consumer accounts (146) of the user (301) with one or more issuers. The user (301) may organize the transactions using information and/or categories identified in the transaction records, such as merchant category, transaction date, amount, etc. Examples and techniques in one embodiment are provided in U.S. Pat. App. Pub. No. 2007/0055597, and entitled “Method and System for Manipulating Purchase Information,” the disclosure of which is hereby incorporated herein by reference.

### TRANSACTION TERMINAL

FIG. 9 illustrates a transaction terminal (144) according to one embodiment. The transaction terminal (144) illustrated in FIG. 9 can be used in various systems discussed in connection with other figures of the present disclosure. In FIG. 9, the transaction terminal (144) is configured to interact with the account identification device (141) to obtain the account information (142) about the consumer account (146).

In one embodiment, the transaction terminal (144) includes a memory (167) coupled to a processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (144) without the physical presence of the account identification device (141). The input device (153) can be configured to provide further information to initiate a transaction, such as a personal identification number (PIN), password, zip code, etc., that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (144) to send an authorization request message to the acquirer processor (147) to initiate a transaction. The transaction terminal (144) may or may not send a separate request for the clearing and settling of the transaction. The instructions stored in the memory (167) are also configured to cause the transaction terminal (144) to perform other types of functions discussed in this description.

In one embodiment, a transaction terminal (144) may have fewer components than those illustrated in FIG. 9. For example, in one embodiment, the transaction terminal (144) is configured for “card-not-present” transactions, and the transaction terminal (144) does not have the reader (163).

In one embodiment, the transaction terminal (144) may have more components than those illustrated in FIG. 9. For example, in one embodiment, the transaction terminal (144) is an ATM machine, which includes components to dispense cash under certain conditions.

### ACCOUNT IDENTIFICATION DEVICE

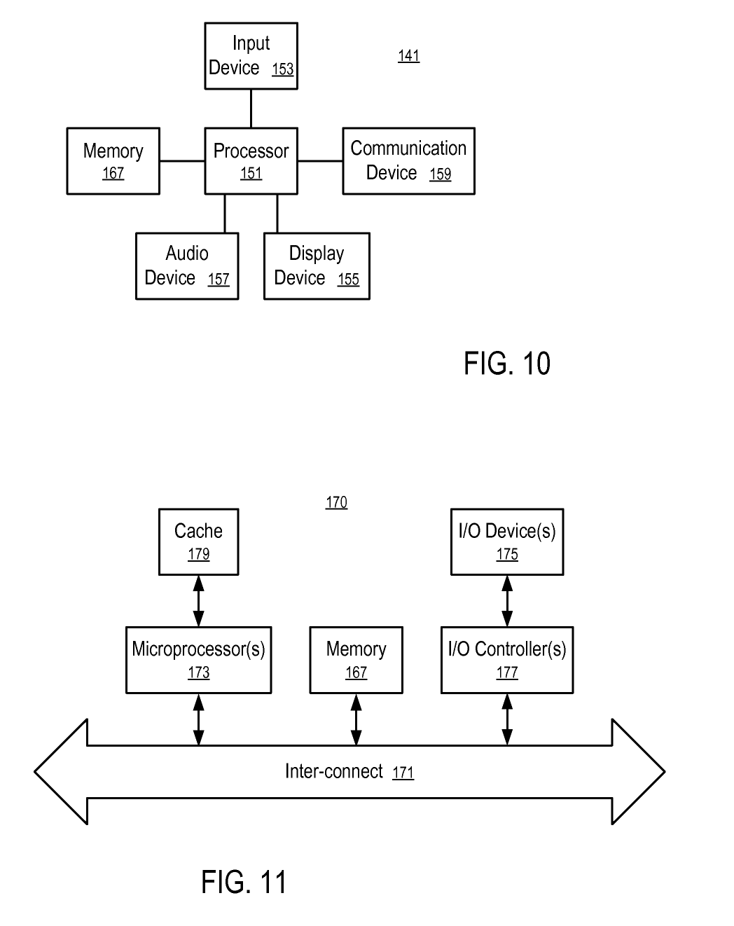

FIG. 10 illustrates an account identifying device according to one embodiment. In FIG. 10, the account identification device (141) is configured to carry the account information (142) that identifies the consumer account (146).

In one embodiment, the account identification device (141) includes the memory (167) coupled to the processor (151), which controls the operations of a communication device (159), the input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account (146) among a plurality of consumer accounts (146) controlled by the issuer processor (145). The account information (142) may include an expiration date of the account identification device (141), the name of the consumer holding the consumer account (146), and/or an identifier identifying the account identification device (141) among a plurality of account identification devices (141) associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory (167) includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently the most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141), and the audio device (157) and the display device (155) may present status information and/or other information, such as advertisements or offers (186). The account identification device (141) may include further components that are not shown in FIG. 10, such as a cellular communications subsystem.

In one embodiment, the communication device (159) may access the account information (142) stored on the memory (167) without going through the processor (151).

In one embodiment, the account identification device (141) has fewer components than those illustrated in FIG. 10. For example, the account identification device (141) does not have the input device (153), the audio device (157) and the display device (155) in one embodiment, and in another embodiment, the account identification device (141) does not have components (151-159).

For example, in one embodiment, the account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide the account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine-readable medium containing the account information (142).

### HARDWARE

In one embodiment, a computing apparatus is configured to include some of the components of systems illustrated in various figures, such as the mobile device (107), the reader (109), the destination account controller (115), the centralized router (101), the data storage (105), the portal (103), the source account controller (117), the transaction handler (143), the data warehouse (149), the issuer processor (145), the acquirer processor (147), the transaction terminal (144), the rule engine (329), the profile generator (323), the message broker (321), the media controller (315), etc.

In one embodiment, at least some of the components can be implemented as a computer system, such as a data processing system (170) illustrated in FIG. 11. Some of the components may share hardware or be combined on a computer system. In one embodiment, a network of computers can be used to implement one or more of the components.

In one embodiment, the transaction handler (143) is a payment processing system, or a payment card processor, such as a card processor for credit cards, debit cards, etc.

FIG. 11 illustrates a data processing system according to one embodiment. While FIG. 11 illustrates various components of a computer system, it is not intended to represent any particular architecture or manner of interconnecting the components. One embodiment may use other systems that have fewer or more components than those shown in FIG. 11.

In FIG. 11, the data processing system (170) includes an inter-connect (171) (e.g., bus and system core logic), which interconnects the microprocessor(s) (173) and the memory (167). The microprocessor (173) is coupled to cache memory (179) in the example of FIG. 11.

In one embodiment, the inter-connect (171) interconnects the microprocessor(s) (173) and the memory (167) together and also interconnects them to input/output (I/O) device(s) (175) via I/O controller(s) (177). The I/O devices (175) may include the display device (155) and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from the execution of the code/instructions by a processor, such as a microprocessor.

Alternatively, or in combination, the functions and operations as described here can be implemented using special purpose circuitry, with or without software instructions, such as Application-Specific Integrated Circuit (ASIC) or Field-Programmable Gate Array (FPGA). Embodiments can be implemented using hardwired circuitry without software instructions or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine-readable medium can be used to store software and data that, when executed by a data processing system, causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in their entirety prior to the execution of the applications. Alternatively, portions of the data and instructions can be obtained dynamically, just in time, when needed for execution. Thus, it is not required that the data and instructions be on a machine-readable medium in their entirety at a particular instance of time.

Examples of computer-readable media include but are not limited to recordable and non-recordable type media, such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine-readable medium and are not configured to store instructions.

In general, a machine-readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### OTHER ASPECTS

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment, and, such references mean at least one.

The use of headings herein is merely provided for ease of reference and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described that may be exhibited by one embodiment and not by others. Similarly, various requirements are described that may be requirements for one embodiment, but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computing system implementing a communication protocol, the computing system comprising:
at least one first computer configured as a centralized router, wherein the centralized router is connected to one or more destination account controllers and one or more source account controllers, and a set of readers are connected to the one or more destination account controllers; and
at least one second computer configured as a data storage, the data storage storing data linking a time limit to identification information of a plurality of destination accounts, wherein:
the centralized router is configured to receive a first authorization request via the one or more destination account controllers, the first authorization request originated from a first reader associated with a first destination account in the plurality of destination accounts, the first authorization request identifying a source identifier to request a resource transfer from a source account identified by the source identifier to the first destination account;
the data storage is configured to store data linking the time limit to the source identifier identified in the first authorization request based on the data linking the time limit with the identification information of the plurality of destination accounts;
the centralized router is further configured to receive a second authorization request via the one or more destination account controllers, the second authorization request originated from a second reader associated with a second destination account in the plurality of destination accounts, the second authorization request identifying the source identifier to request a resource transfer from the source account identified by the source identifier to the second destination account;
in response to a determination that the second authorization request is within the time limit linked to the source identifier in the data storage, the data storage is configured to increase an allocated resource of the source identifier, based on the data linking the time limit with the identification information of the plurality of destination accounts and the data linking the time limit to the source identifier;
the centralized router is further configured to receive a third authorization request via the one or more destination account controllers, the third authorization request originated from a third reader associated with a third destination account in the plurality of destination accounts to request a requested resource identified in the third authorization request to be transferred from the source account identified by the source identifier to the third destination account; and
from the third authorization request, the centralized router is further configured to
determine an adjusted resource from the requested resource and the allocated resource of the source identifier, based on the data linking the time limit with the identification information of the plurality of destination accounts and the data linking the time limit to the source identifier,
transmit a fourth authorization request, that replaces the third authorization request, to a source account controller of the source account identified by the source identifier to request a transfer of the adjusted resource from the source account to the third destination account, and
route a response to the fourth authorization request from the source account controller to the third reader via the one or more destination account controllers.

2. The computing system of claim 1, further comprising:
at least one third computer configured as a portal connected to the data storage;
wherein the data storage is further configured to store, in association with the source identifier, a communication reference of a mobile device in response to the first authorization request; and
wherein the portal is configured to communicate, to the mobile device using the communication reference, a status of the allocated resource via a communication connection that does not go through the one or more destination account controllers.

3. The computing system of claim 2, wherein the centralized router is further configured to provide, in a response to the first authorization request, a portal address that is presented by the first reader; and
wherein the portal is further configured to receive, via the portal address provided in the response to the first authorization request, the communication reference of the mobile device to store the communication reference of the mobile device in association with the source identifier.

4. The computing system of claim 2, where the first authorization request includes the communication reference; and the response to the first authorization request identifies the time limit.

5. The computing system of claim 2, wherein the centralized router is further configured to determine shares of the allocated resources allocated from the plurality of destination accounts, and initiate transfers from the plurality of destination accounts to the third destination account according to the shares responsive to the response to the fourth authorization request.

6. The computing system of claim 1, wherein the third authorization request is determined to be within the time limit linked to the source identifier in the data storage, prior to the determining of the adjusted resource.

7. The computing system of claim 6, wherein the time limit is predetermined before the first authorization request; and the identification information of the plurality of destination accounts is predetermined and associated with the time limit before the first authorization request.

8. The computing system of claim 1, wherein the data storage is further configured to store an allocation record identifying an increase of the allocated resource in connection with the second authorization request.

9. A non-transitory computer storage medium storing instructions configured to instruct a computing device in a computing system having a plurality of computers to implement a communication protocol, the communication protocol comprising:
storing, in a plurality of computers including a data storage coupled to a centralized router, data linking a time limit to identification information of a plurality of destination accounts, wherein the centralized router is connected to one or more destination account controllers and one or more source account controllers, and a set of readers are connected to the one or more destination account controllers;
receiving, in the centralized router, a first authorization request via the one or more destination account controllers, the first authorization request originated from a first reader associated with a first destination account in the plurality of destination accounts, the first authorization request identifying a source identifier to request a resource transfer from a source account identified by the source identifier to the first destination account;
storing, in the data storage, data linking the time limit to the source identifier identified in the first authorization request based on the data linking the time limit with the identification information of the plurality of destination accounts;
receiving, in the centralized router, a second authorization request via the one or more destination account controllers, the second authorization request originated from a second reader associated with a second destination account in the plurality of destination accounts, the second authorization request identifying the source identifier to request a resource transfer from the source account identified by the source identifier to the second destination account;
determining that the second authorization request is within the time limit linked to the source identifier in the data storage;
increasing, in the data storage, an allocated resource of the source identifier, based on the data linking the time limit with the identification information of the plurality of destination accounts and the data linking the time limit to the source identifier;
receiving, in the centralized router, a third authorization request via the one or more destination account controllers, the third authorization request originated from a third reader associated with a third destination account in the plurality of destination accounts to request a requested resource identified in the third authorization request to be transferred from the source account identified by the source identifier to the third destination account;
determining, from the third authorization request, an adjusted resource from the requested resource and the allocated resource of the source identifier, based on the data linking the time limit with the identification information of the plurality of destination accounts and the data linking the time limit to the source identifier;
transmitting, by the centralized router, a fourth authorization request, that replaces the third authorization request, to a source account controller of the source account identified by the source identifier to request a transfer of the adjusted resource from the source account to the third destination account; and
routing, by the centralized router, a response to the fourth authorization request from the source account controller to the third reader via the one or more destination account controllers.

10. A method for a communication protocol implemented in a computing system, the method comprising:
providing a plurality of computers, including a centralized router, and a data storage storing data linking a time limit to identification information of a plurality of destination accounts, wherein the centralized router is connected to one or more destination account controllers and one or more source account controllers, and a set of readers are connected to the one or more destination account controllers;
receiving, in the centralized router, a first authorization request via the one or more destination account controllers, the first authorization request originated from a first reader associated with a first destination account in the plurality of destination accounts, the first authorization request identifying a source identifier to request a resource transfer from a source account identified by the source identifier to the first destination account;
storing, in the data storage, data linking the time limit to the source identifier identified in the first authorization request based on the data linking the time limit with the identification information of the plurality of destination accounts;
receiving, in the centralized router, a second authorization request via the one or more destination account controllers, the second authorization request originated from a second reader associated with a second destination account in the plurality of destination accounts, the second authorization request identifying the source identifier to request a resource transfer from the source account identified by the source identifier to the second destination account;
determining that the second authorization request is within the time limit linked to the source identifier in the data storage;
increasing, in the data storage, an allocated resource of the source identifier, based on the data linking the time limit with the identification information of the plurality of destination accounts and the data linking the time limit to the source identifier;
receiving, in the centralized router, a third authorization request via the one or more destination account controllers, the third authorization request originated from a third reader associated with a third destination account in the plurality of destination accounts to request a requested resource identified in the third authorization request to be transferred from the source account identified by the source identifier to the third destination account;
determining, from the third authorization request, an adjusted resource from the requested resource and the allocated resource of the source identifier, based on the data linking the time limit with the identification information of the plurality of destination accounts and the data linking the time limit to the source identifier;
transmitting, by the centralized router, a fourth authorization request, that replaces the third authorization request, to a source account controller of the source account identified by the source identifier to request a transfer of the adjusted resource from the source account to the third destination account; and
routing, by the centralized router, a response to the fourth authorization request from the source account controller to the third reader via the one or more destination account controllers.

11. The method of claim 10, further comprising:
determining that the third authorization request is within the time limit linked to the source identifier in the data storage, prior to the determining of the adjusted resource.

12. The method of claim 11, wherein the time limit is predetermined before the first authorization request.

13. The method of claim 12, wherein the identification information of the plurality of destination accounts is predetermined and associated with the time limit before the first authorization request.

14. The method of claim 10, further comprising:
storing, in the data storage, an allocation record identifying an increase of the allocated resource in connection with the second authorization request.

15. The method of claim 10, wherein the plurality of destination accounts are associated with different category codes of resource transfers.

16. The method of claim 10, wherein the plurality of computers includes a portal connected to the data storage; and the method further comprises:
storing, in the data storage and in association with the source identifier, a communication reference of a mobile device in response to the first authorization request; and
communicating, from the portal to the mobile device using the communication reference, a status of the allocated resource via a communication connection that does not go through the one or more destination account controllers.

17. The method of claim 16, further comprising:
providing, by the centralized router and in a response to the first authorization request, a portal address that is presented by the first reader; and
receiving, in the portal via the portal address provided in the response to the first authorization request, the communication reference of the mobile device to store the communication reference of the mobile device in association with the source identifier.

18. The method of claim 16, where the first authorization request includes the communication reference.

19. The method of claim 18, wherein the response to the first authorization request identifies the time limit.

20. The method of claim 10, further comprising:
determining, by the centralized router, shares of the allocated resources allocated from the plurality of destination accounts; and
initiating, by the centralization router, transfers from the plurality of destination accounts to the third destination account according to the shares responsive to the response to the fourth authorization request.
